(19) United States
(12) Patent Application Publication
(10) Pub. No.: US 2001/0055214 A1
(43) Pub. Date: Dec. 27, 2001

(54) Rear-view mirror device for vehicle and method for making the same

(76) Inventor: Chia-Jung Chang, Taipei (TW)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/866,480

(22) Filed: May 29, 2001

(30) Foreign Application Priority Data
May 29, 2000 (TW) 89110342

(51) Int. Cl. B60R 1/12; B60Q 1/26

(52) U.S. Cl. 362/494; 362/135; 362/284; 40/556

(57) ABSTRACT

A rear-view mirror device is provided that includes a transparent or semitransparent casing having a coating layer applied thereon. At least a light-transmissible portion is formed on the casing by removing a predetermined portion of the coating layer on the casing and a light source is installed within the casing for generating light to be emitted from the light-transmissible portion to the outside of the casing, allowing the rear-view mirror device to serve as a turning signal. The casing is then attached with a cover having a mirror piece, so as to enclose the light source in the casing.

### BACKGROUND OF THE INVENTION

1. Field of the Invention

The present invention relates to rear-view mirror devices and, more particularly, to a rear-view mirror device for vehicle that allows a vehicle driver to view the traffic condition behind the vehicle driven by the driver.

2. Description of Prior Art

The rear-view mirrors installed on vehicles such as automobiles and motorcycles are used by motorists to view the traffic condition behind their vehicles therefrom. In recent years, as shown in FIG. 1, it can be seen that some rear-view mirrors are each provided with a turning signal composed of a lamp hood 200, a reflective cone 202 and a lamp bulb 204, for providing the rear-view mirror with indicator-lamp function.

The above structure is capable of providing a rear-view mirror with dual functions. However, a conventional rear-view mirror 100, as shown in FIG. 1, which includes a casing 400 and a cover 300 coupled to the casing 400, is required to alter the design of the casing 400 so as to receive the reflective cone 202. When a significant portion of the inner space of the casing 400 has been occupied by the reflective cone 202 of the turning signal, an electric driving unit (not shown), received in the casing 400, for driving the mirror piece of the rear-view mirror to a desired angle appreciated by the motorist, has to be redesigned to be adapted to the mounting of the reflective cone 202. As a result, rear-view mirror manufacturers are required to re-mold the casing for the rear-view mirror and produce a new electric driving unit. This is not only cost-ineffective but also time-consuming to make such a single turning signal that is not universally fit to various kinds of rear-view mirrors.

### SUMMARY OF THE INVENTION

The primary objective of the present invention is to provide a rear-view mirror device that is capable of incorporating a turning signal in a cost-effective manner.

Another objective of this invention is to provide a rear-view mirror device that is capable of incorporating a turning signal without changing the structural design of the rear-view mirror device.

A further objective of this invention is to provide a method for making a rear-view mirror device for a vehicle which is universally applicable to various kinds of rear-view mirror devices mounted with turning signals, and which is capable of using existing molds for forming the rear-view mirror device.

To achieve the above and other objectives, the present invention provides a method for making a rear-view mirror device for vehicle which comprises the steps of: preparing a transparent or semi-transparent casing for being attached with a cover having a mirror piece to form the rear-view mirror set; applying a coating layer to the casing with a desired color for making the casing opaque; removing a predetermined portion of the coating layer on the casing so as to form a light-transmissible portion with a desired pattern; mounting in the casing a light source electrically connected to control unit installed in the vehicle, so as to allow the light beam generated by the light source to emit from the light-transmissible portion to the outside of the casing by means of the control of the control unit; and attaching the cover to the casing.

To protect the coating layer applied on the casing from peeling off, the method of this invention also includes a step of applying a transparent protective layer over the coating layer after the light-transmissible portion on the casing has been formed by conventional layer engraving technology.

It is preferable to use SMD (Surface Mount Devices) or (high-brightness) LED (Light Emitting Diode) as the light source, and the SMD or LED is preferably disposed in close contact with the inner surface of the casing. Also, SMD or LED shall be capable of emitting red or yellow light and controllable of the flashing speed.

This invention also provides a rear-view mirror device for vehicle that includes a casing made of a transparent or semi-transparent material and being coated with a coating layer, on the casing at least a light-transmissible portion being formed by removing a pre-determined portion of the coating layer, a light source mounted in the casing and electrically connected to a control unit installed in the vehicle for emitting light beam to the outside of the casing via the light-transmissible portion on the casing by means of the control of the control unit; and a cover having a mirror piece for attaching to the casing to form the rear-view mirror device.

### BRIEF DESCRIPTION OF DRAWINGS

The invention can be more fully understood by reading the following detailed description of the preferred embodiments, with reference made to the accompanying drawings, wherein:

FIG. 1 is a partially exploded view of a conventional rear-view mirror combining a turning signal;

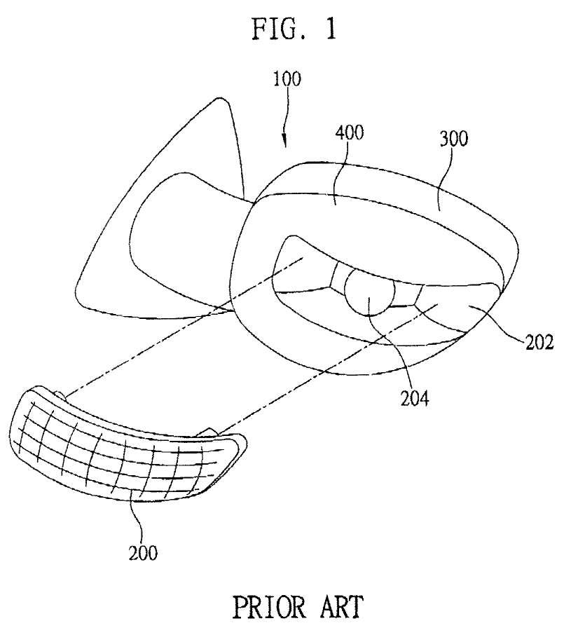

FIGS. 2(a) to 2(c) are schematic views used to illustrate the steps for making the casing of the rear-view mirror device in accordance with the present invention;

FIG. 3 is a sectional view of the rear-view mirror device in accordance with

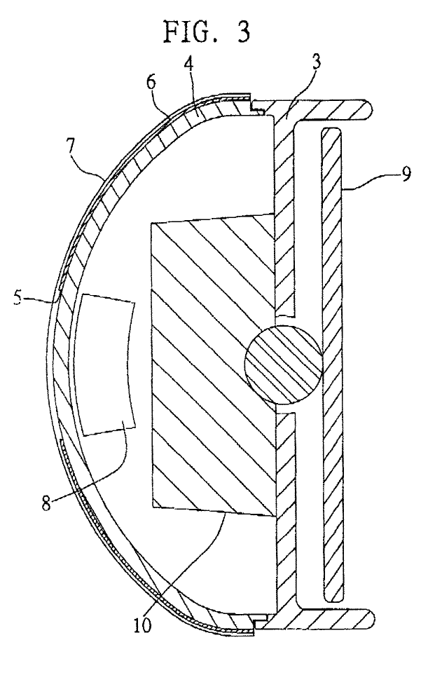

FIG. 4 is a perspective view of another preferred embodiment of the rear-view mirror device in accordance with the present invention.

### DETAILED DESCRIPTION OF THIS INVENTION

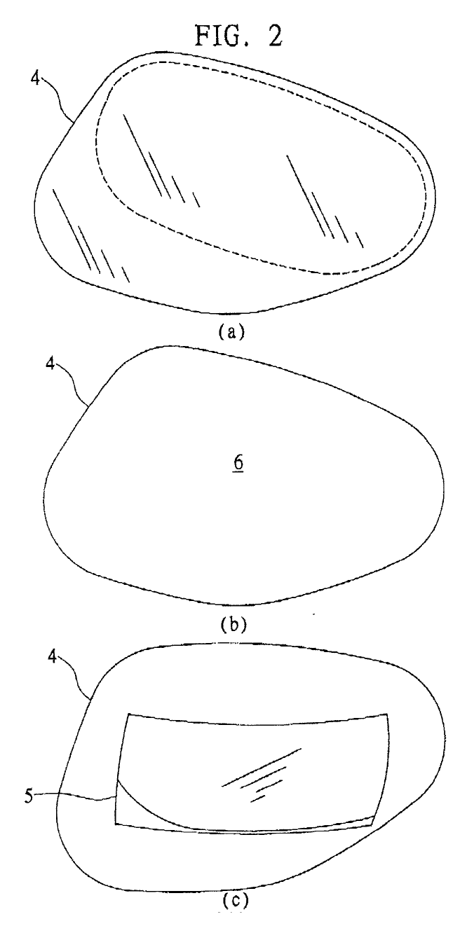

FIGS. 2(a) to 2(c) are drawings used to illustrate the steps taken in the method of making a rear-view mirror device for vehicle according to the present invention.

The first step of the method of this invention is to prepare a transparent or semi-transparent casing 4 via conventional injection molding process. Appropriate material for forming the casing 4 may be conventional colorless, transparent ABS polymer or the like. Alternatively, a colorant can be added to the colorless, transparent polymeric material to make the casing 4 semi-transparent.

The next step of the method of this invention is to apply a coating layer 6 to merely the inner surface or the outer surface or to both the outer and inner surfaces of the casing 4, by conventional coating, spraying or vacuum plating surface treatment. Of course, the application of the coating layer 6 to the outer surface of the casing 4 is preferred. The application of the coating layer 6 to the casing 4 allows the casing 4 to become opaque, as shown in FIG. 2(b). Then, laser engraving technique is employed to remove a predetermined portion of the coating layer 6 on the casing 4, so that a desired pattern can be obtained to form as a light-transmissible portion 5, as shown in FIG. 2(c), which allows light to pass therethrough.

After the light-transmissible portion 5 is formed on the casing 4, a layer of wear-resistant transparent paint (such as PU) is sprayed on the outer surface of the casing 4, forming a protective layer 7 to protect the coating layer 6 on the outer surface of the casing 4, and to ensure the integrity of the light transmissible portion 5. If the coating layer 6 is formed on the inner-surface of the casing 4, this step of applying the protective layer 7 to the casing 4 can be omitted.

Then, a light source 8 is installed within the casing 4 in a manner that the light source 8 is electrically connected to a control unit installed in a vehicle with which the rear-view mirror device according to this invention is mounted, so as to allow the control unit to control the light source 8 to emit light, when in need. At the time the light source 8 is lit, the light beam generated by the light source 8 can be omitted to the outside of the casing 4 via the light-transmissible portion 5. As the control unit and the electrical connection between the light source 8 and the control unit are conventional, they are thus omitted from being illustrated in the drawings for simplification purpose.

Finally, a cover 3 coupled with a mirror piece 9 is fixed to the casing 4 by any conventional fixing approaches. This completes the process for making the rear-view mirror device of this invention.

The light source 8 employed in this invention may be a small-sized SMD or LED, which can be directly fixed onto the inner surface of the casing 4 or coupled to an electric driving unit 10 attached to the mirror piece 9 of the cover 3 for driving the mirror piece 9 to a desired angle.

Therefore, as the light emitted from the light source 8 can penetrate the light-transmissible portion 5 to the outside of the casing 4, the rear-view mirror device of this invention can serve as a turning signal.

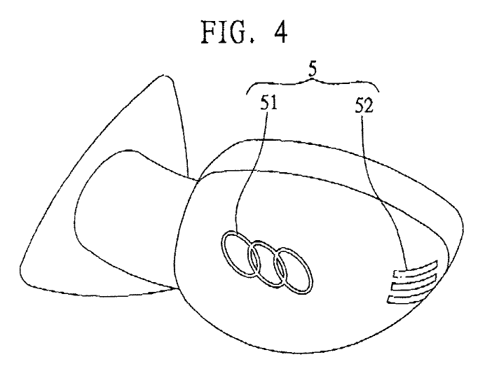

This invention utilizes laser engraving technology to form the light-transmissible portion 5 in any desired and complicated pattern, so when the light-transmissible portion 5 is formed with a car manufacturer's logo, the rear-view mirror device according to this invention will have the function of identifying the car maker's brand name, in addition to having the function of serving as a turning signal, as shown in FIG. 4. In the drawing, the light-transmissible portion 5 includes a trademark pattern 51 and an turning signal pattern 52.

The light-transmissible portion 5 on the casing 4 can also be formed into a screen shape, allowing the light source 8 via the control of control unit to produce appropriate wording display through the light-transmissible portion 5. Therefore, the rear-view mirror device of this invention can serve as a message, commercial ad or running screen media. For example, when the vehicle mounted with the rear-view mirror device of this invention stops by the roadside, the light-transmissible portion 5 of the casing 4 in a screen shape can show the wordings “Park here for a moment only” or “Phase call the number of XXXX-XXXX” or otherwise.

In conclusion, the rear-view mirror device of this invention which can serve as a turning signal, can be made simply by forming a light-transmissible portion on the casing with a conventional shape and design and incorporating a light source in the casing. Accordingly, as the casing can be made with any conventional and existing molds, the rear-view mirror device of this invention is cost-effective and time-saving to manufacture and to cope with various needs on designs.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for making a rear-view mirror device for vehicle, comprising the steps of:
preparing a transparent or semi-transparent casing for being attached with a cover having a mirror piece;
applying a coating layer to the casing for making the casing opaque;
removing a predetermined portion of the coating layer on the casing to form at least a light-transmissible portion with a desired pattern;
installing in the casing a light source which is electrically connected to a control unit installed in the mounting base, and assembly of said mirror shield and said mirror mounting vehicle, allowing the light source via the control of the control unit to emit light through the light-transmissible portion to the outside of the casing; and
attaching the cover to the casing.

2. The method of claim 1, further comprising the step of applying a transparent protective layer on the casing over the coating layer.

3. The method of claim 1, wherein the light-transmissible portion is formed by laser engraving technology.

4. The method of claim 1, wherein the light source is SMD.

5. The method of claim 1, wherein the light source is LED.

6. The method of claim 1, further comprising the step of coupling an electric driving unit to the mirror piece of the cover for driving the mirror piece to a desired angle relative to the cover.

7. The method of claim 1, wherein the light source is directly attached to the casing.

8. The method of claim 6, wherein the light source is coupled with the electric driving unit.

9. A rear-view mirror device for vehicle, comprising:
a casing made of a transparent or semi-transparent material and being coated with a coating layer, on the casing at least a light-transmissible portion being formed by removing a predetermined portion of the coating layer on the casing;
a light source installed within the casing and electrically connected to a control unit installed in the vehicle for emitting light to the outside of the casing via the light-transmissible portion on the casing by means of the control of the control unit, and
a cover having a mirror-piece for attaching to the casing.

10. The device of claim 9, further comprising a transparent protective layer over the coating layer and the light-transmissible portion formed on the casing.

11. The device of claim 9, wherein the light-transmissible portion is formed by laser engraving technology.

12. The device of claim 9, wherein the light source is SMD.

13. The device of claim 9, wherein the light source is LED.

14. The device of claim 9, further comprising an electric driving unit coupled to the mirror piece of the cover for driving the mirror piece to a desired angle relative to the cover.

15. The device of claim 9, wherein the light source is directly attached to the casing.

16. The device of claim 14, wherein the light source is coupled with the electric driving unit.
